(19) United States
(12) Patent Application Publication
(10) Pub. No.: US 2024/0068892 A1
(43) Pub. Date: Feb. 29, 2024

(54) WALL SHEAR STRESS SENSOR

(71) Applicant: University of Newcastle upon Tyne, Newcastle upon Tyne, Tyne and Wear (GB)

(72) Inventors: Richard David Whalley, Newcastle upon Tyne, Tyne and Wear (GB); Nima Ebrahimzade, Newcastle upon Tyne, Tyne and Wear (GB)

(73) Assignee: University of Newcastle upon Tyne, Newcastle upon Tyne, Tyne and Wear (GB)

(21) Appl. No.: 18/272,269

(22) PCT Filed: Dec. 14, 2021
(86) PCT No.: PCT/GB2021/053279

§ 371 Date: Jul. 13, 2023

(30) Foreign Application Priority Data
Jan. 15, 2021 (GB) 2100564.0

(51) Int. Cl. G01L 1/24

(52) U.S. Cl. CPC G01L 1/242

(57) ABSTRACT

A two-dimensional wall shear stress sensor comprising fixed and floating substrates, an incident light source and first and second photodetectors. The fixed substrate supports a first plurality of optical gratings. The floating substrate supports a second plurality of optical gratings superimposed over the first plurality of optical gratings to form a plurality of Moire fringe patterns comprising at least a first Moire fringe pattern extending in a first direction and a second Moire fringe pattern extending in a second direction different to the first direction. The floating substrate is displaceable relative to the fixed substrate in response to a wall shear stress imparted on the sensor, wherein displacement of the floating substrate correlates with a phase shift in at least one of the first and second Moire fringe patterns. An incident light source is configured to illuminate each of the plurality of Moire fringe patterns. The first photodetector system is configured to detect intensity of light reflected from the first Moire fringe pattern. The second photodetector system is configured to

The present invention relates to a wall shear stress sensor. In particular, but not exclusively, the present invention relates to an optical micro-electro-mechanical system (MEMS) wall shear stress sensor and wall shear stress detector system.

### BACKGROUND

Knowledge of instantaneous wall shear stress is vital to deepen physical understanding of wall-turbulent flows. The ability to measure wall shear stress in both one and two dimensions over a surface area would be highly beneficial to the field of fluid dynamics and hence the development of more efficient aircraft or high-speed transportation, for example. Such sensors would also be useful, for example in wind tunnel operations, aerospace, both high performance and domestic automotive, and in the rail industry.

Some known wall shear stress sensors use a shift phase in a Moiré fringe pattern to measure wall shear stress. This has been carried out using optical methods, which have several advantages over the use of electrical sensors. For example, fibre optics are insensitive to and do not produce electromagnetic interference, and they suffer minimal signal degradation even over long cable lengths. They can also be used at higher temperatures compared to conventional sensors.

US2006/137467 A1 discloses a floating element shear-stress sensor using an optical Moiré transduction technique. The described setup utilises an optical microscope to interpret the shift in the Moiré fringe patterns. However, this results in a relatively bulky system, which may be difficult to implement in many applications.

US2011/0032512 A1 discloses a floating element shear-stress sensor in which the displacement of the floating element is detected through use of optical measurements. An optical fibre is positioned in proximity to the floating element to deliver the optical signal to the floating element, whilst another optical fibre in proximity to the floating element receives a reflected light signal.

US2018/0252600 discloses a MEMS capacitive wall shear stress vector measurement system, which is a capacitive device. Such capacitive devices can have drawbacks such as reliability at high temperatures and will likely suffer from electrical noise.

It is an object of the invention to provide a wall shear stress sensor having improved resolution whilst minimising size.

### SUMMARY OF THE INVENTION

According to a first aspect of the invention, there is provided a two-dimensional wall shear stress sensor comprising: a fixed substrate supporting a first plurality of optical gratings; a floating substrate supporting a second plurality of optical gratings superimposed over the first plurality of optical gratings to form a plurality of Moiré fringe patterns comprising at least a first Moiré fringe pattern extending in a first direction and a second Moiré fringe pattern extending in a second direction different to the first direction; wherein the floating substrate is displaceable relative to the fixed substrate in response to a wall shear stress imparted on the sensor, wherein displacement of the floating substrate correlates with a phase shift in at least one of the first and second Moiré fringe patterns; an incident light source configured to illuminate each of the plurality of Moiré fringe patterns; a first photodetector system configured to detect intensity of light reflected from the first Moiré fringe pattern; and a second photodetector system configured to detect intensity of light reflected from the second Moiré fringe pattern.

According to a second aspect of the invention, there is provided a one dimensional wall shear stress sensor comprising: a first optical grating; a second optical grating overlapping the first optical grating such that the first optical grating and second optical grating form a Moiré fringe pattern, wherein the second optical grating is displaceable relative to the first optical grating in response to a wall shear stress imparted on the sensor, and wherein displacement of the second optical grating correlates with a phase shift in the Moiré fringe pattern; an incident light source configured to illuminate at least a first discrete location and a second discrete location on the Moiré fringe pattern; a first photodetector configured to detect light intensity reflected from the first discrete location; and a second photodetector configured to detect light intensity reflected from the second discrete location.

Certain aspects of the invention provide the advantage of more sensitive sensors with higher accuracy and resolution compared to previously known sensors.

Certain aspects of the invention provide the advantage of improved resolution in comparison to sensor size, enabling the production of smaller MEMS sensors without compromising on sensor resolution.

Certain aspects of the invention provide improved measurement of wall shear stress in two dimensions compared to known techniques.

### BRIEF DESCRIPTION OF THE DRAWINGS

Embodiments of the invention are now described, by way of example only, hereinafter with reference to the accompanying drawings, in which:

FIG. 1. illustrates a wall shear stress sensor pad having a serpentine micro-spring arrangement;

FIG. 2. illustrates a section A-A of the wall shear stress sensor pad of FIG. 1;

FIG. 3. illustrates a wall shear stress sensor pad having a clamped micro-spring arrangement;

FIG. 4. illustrates the formation of a Moiré fringe pattern from two optical gratings;

FIG. 5a. illustrates an SEM image of a Moiré fringe pattern;

FIG. 5b. illustrates the reflected light intensity profile of the Moiré fringe pattern of FIG. 5a;

FIG. 6a. illustrates a distribution of light spots across the Moiré fringe pattern;

FIG. 6b. illustrates corresponding reflected light intensity of each light spot of FIG. 6a and the corresponding position on a fitted sine curve;

FIG. 7a. illustrates a wall shear stress sensor pad with the possible positioning of illuminated spots on the Moiré fringe pattern indicated;

FIG. 7b. illustrates modelling of the Moiré fringe pattern as a sinusoidal function;

FIG. 8. illustrates an example relationship between Moiré fringe pattern displacement, phase difference, and applied wall shear stress;

FIG. 9a. illustrates an example two-dimensional wall shear stress sensor pad;

FIG. 9b. illustrates an SEM image of an example two-dimensional wall shear stress sensor pad;

FIG. 10. illustrates an example wall shear stress sensor system;

FIG. 11a. illustrates an example housing or packaging for a wall shear stress sensor;

FIG. 11b. illustrates a sectional view of the housing of FIG. 11a;

FIG. 12. illustrates an SEM image of a wall shear stress sensor array;

FIG. 13a. illustrates probability density functions of fluctuating wall shear stress;

FIG. 13b. illustrates probability density functions of normalised fluctuating wall shear stress; and

FIG. 14. illustrates a dynamic harmonic response curve.

In the drawings, like reference numerals refer to like parts.

### DETAILED DESCRIPTION

Certain terminology is used in the following description for convenience only and is not limiting. For example, unless otherwise specified, the use of ordinal adjectives, such as, ‘first’, ‘second’, ‘third’ etc. merely indicate that different instances of like objects are being referred to and are not intended to imply that the objects so described must be in a given sequence, either temporally, spatially, in ranking or in any other manner.

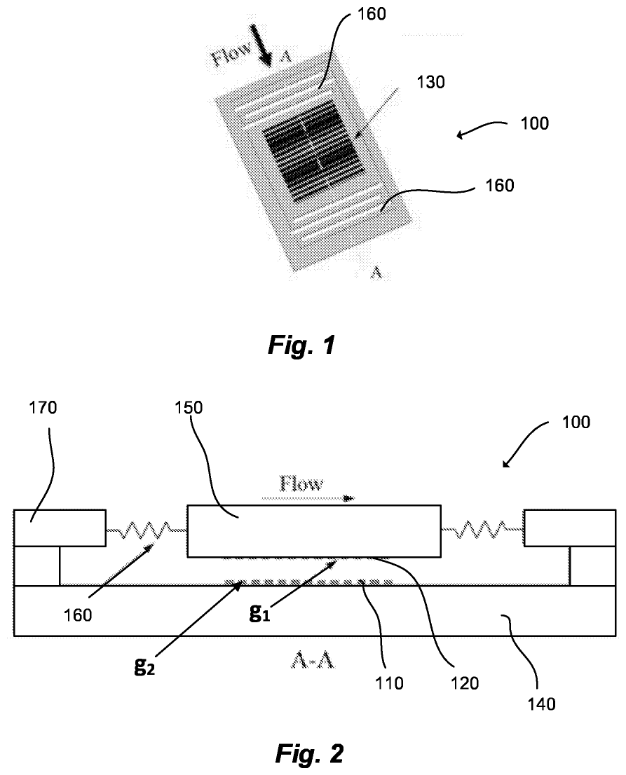

FIGS. 1 and 2 illustrate a wall shear stress sensor pad 100 of a wall shear stress sensor. The wall shear stress sensor may aptly be a micro-electro-mechanical-systems (MEMS) wall shear stress sensor. Such sensors typically have a sensor pad that is less than 1 mm in size at the largest dimension. In use, the sensor pad 100 may be mounted substantially flush with a surface over which fluid flow passes.

The wall shear stress sensor pad 100 includes a first optical grating 110 and a second optical grating 120. The second optical grating 120 is positioned to overlap the first optical grating 110. In other words, the second optical grating 120 is superimposed over the first optical grating 110.

The overlapped first optical grating 110 and second optical grating 120 together form a Moiré fringe pattern 130. For example, as shown in FIG. 4, first and second optical gratings may have respective first and second pitches, g₁ and g₂. The first and second pitches g₁ and g₂ may be different. g₁ and g₂ may be selected according to the desired pitch, G, of the Moiré fringe pattern. For example, g₁ and g₂ may be around 3 to 4 microns and 7 to 8 microns respectively. In this example, g₁ is 3.75 microns and g₂ is 7.6 microns.

When the first and second optical gratings 110, 120 are superimposed with respect to each other, they form a Moiré fringe pattern having a pitch G. The relationship between the pitch of the Moiré fringe pattern and the pitch of each optical grating may be defined according to Equation 1:

$$\frac{1}{G} = \frac{1}{{g}_{1}} - \frac{1}{{g}_{2}}$$

The second optical grating 120 is displaceable relative to the first optical grating in response to a wall shear stress imparted on the sensor pad 100. For example, a flow across the sensor pad in the direction indicated in FIGS. 1 and 2 will result in translational movement or displacement of the second optical grating 120 in the same direction as the flow. Displacement of the second optical grating 120 with respect to the first optical grating 110 results in a phase shift or displacement in the corresponding Moiré fringe pattern 130.

The displacement, Δ, of the Moiré fringe pattern 130 in relation to the physical displacement, δ, of the second optical grating 130 may be defined according to Equation 2:

$$Δ = ( \frac{G}{{g}_{1}} ) δ$$

As such, wall shear stress forces imparted on the sensor 100 correlate with the phase shift in the Moiré fringe pattern 130. Measurement of the phase shift or displacement in the Moiré fringe pattern 130 thereby enables measurement of the wall shear stress imparted on the sensor 100.

The position of the Moiré fringe pattern 130 may be determined by measuring an intensity of light reflected therefrom. For example, an incident light source may illuminate a back side of the Moiré fringe pattern 130. Intensity of light reflected from the Moiré fringe pattern 130 may be measured by a photodetector system. The “light” bands of the Moiré fringe pattern will reflect higher light intensity than the “dark” bands on the Moiré fringe pattern.

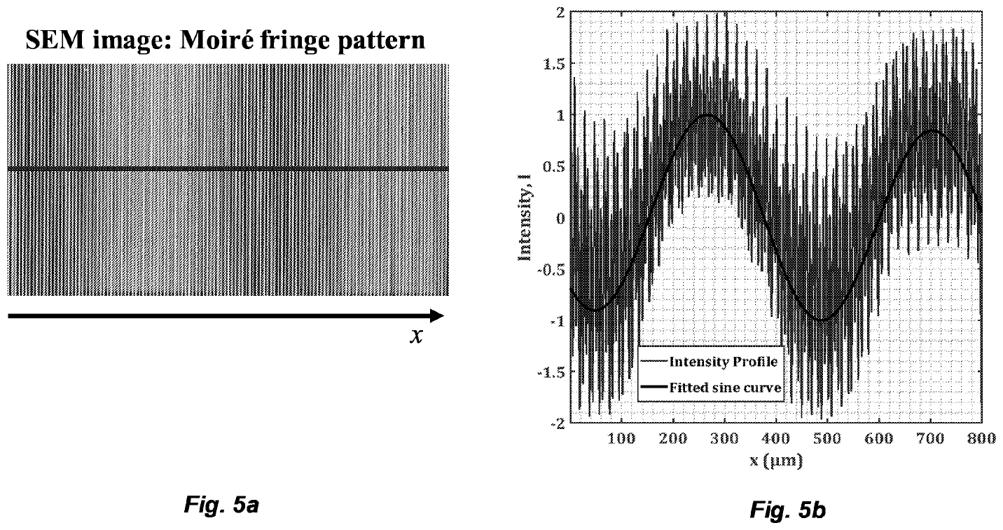

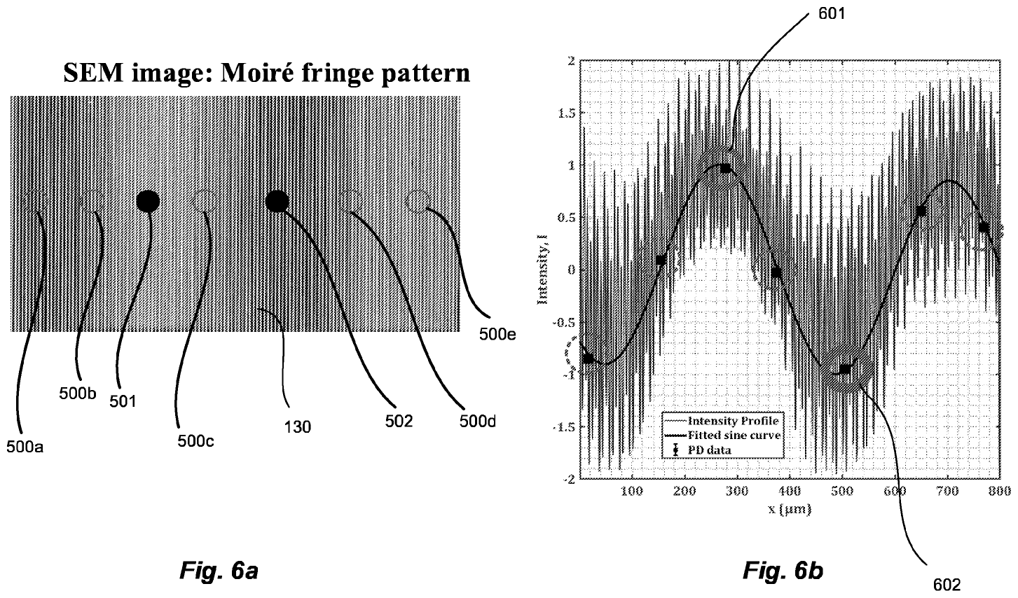

As illustrated in FIGS. 5a, 5b, 6a and 6b, the intensity of light reflected from the Moiré fringe pattern may be modelled as a sinusoidal function. A phase shift of the sinusoidal function is directly related to displacement of the second optical grating 120 and wall shear stress.

In this example, an incident light source is configured to illuminate at least a first discrete location 501 and a second discrete location 502 on the Moiré fringe pattern 130. The first and second discrete locations 501, 502 are spaced apart in the x direction of the Moiré fringe pattern 130.

That is, the incident light source is configured to project light onto the first and second discrete locations spaced apart on the Moiré fringe pattern 130. The first discrete location 501 is spaced apart from an adjacent discrete location 502 in the x direction as shown in FIG. 6a. In this way, each discrete location will correspond to a different point on the Moiré fringe pattern such that light reflected from each discrete location may have a different intensity depending on the position of the “light” and “dark” bands of the Moiré fringe pattern 130.

The incident light source is aptly positioned to project light onto a back side of Moiré fringe pattern 130. For the example shown in FIGS. 1 and 2, the incident light source may be positioned to project light through a transparent substrate 140 onto the Moiré fringe pattern 130.

A photodetector system is configured to detect light intensity reflected from each discrete location on the Moiré fringe pattern 130. As illustrated in FIGS. 6a and 6b, intensity of light reflected from each of the discrete locations 501, 502 can be mapped to reveal the sinusoidal response of the Moiré fringe pattern. As shown, in this example, light reflected from the first discrete location 501 corresponds substantially to a peak of the sinusoidal response at 601, whilst light reflected from the second discrete location 502 corresponds substantially to a trough of the sinusoidal response at 602. In this way, the phase shift (or displacement) of the Moiré fringe pattern 130 over time, and therefore the displacement of the second optical grating 120 with respect to the first optical grating 110 can be determined.

In other examples the light spots may be projected towards different or additional discrete locations, for example one or more of the discrete locations 500a-e outlined in FIG. 6a. The corresponding reflected light intensity for each of these discrete locations can be seen in FIG. 6b, as represented by the data points in dashed circles. As shown, the reflected light intensity at each discrete location 500a-e corresponds to a discrete sinusoidal response on the sinusoidal curve shown in FIG. 6b.

As mentioned above, the incident light source is configured to illuminate at least a first and second discrete location 501, 502 distributed across the Moiré fringe pattern 130. Each of the discrete locations are aptly spaced apart on the Moiré fringe pattern in the x direction. That is, the discrete locations are distributed along the translational axis of the second optical grating 120 and, therefore, of the Moiré fringe pattern 130.

The incident light source may be configured to provide constant illumination to each of the first and second discrete locations 501, 502. That is, the first discrete location and the second discrete location may be constantly and simultaneously illuminated by the incident light source.

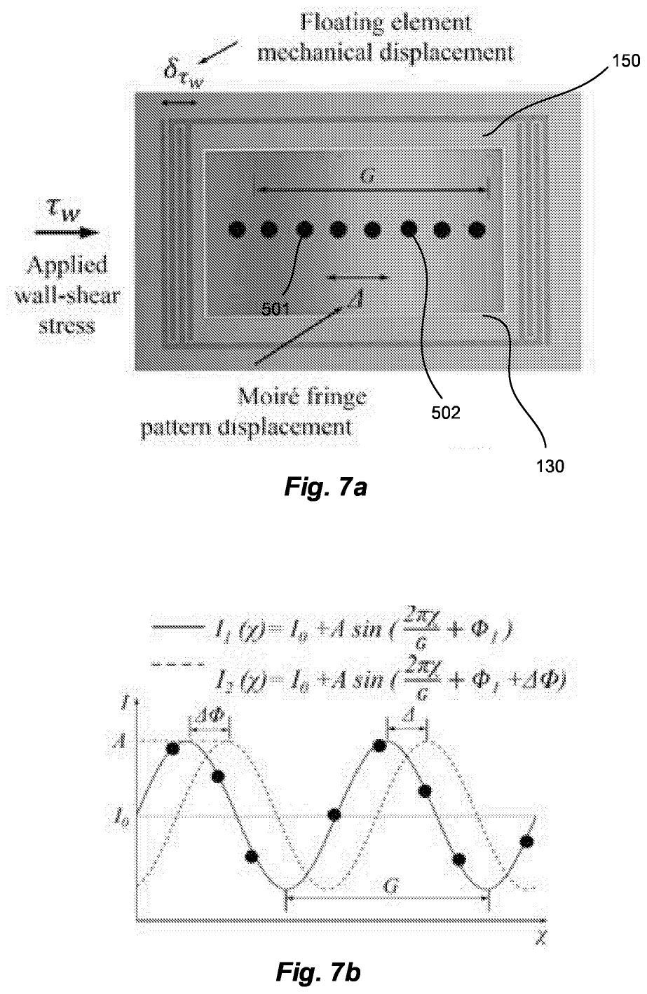

In other words, the incident light source is configured to project a light spot onto each discrete location on the Moiré fringe pattern. As the second optical grating displaces within air flow, for example, the phase of the sinusoidal response of the Moiré fringe pattern may be tracked with time by the photodetector system. An example of this phase shift tracking is illustrated in FIGS. 7a and 7b. For illustration purposes, eight projected light spots are shown in FIGS. 7a and 7b. However, it will be appreciated that only two or more light spots may be projected onto the Moiré fringe pattern. For example, only two spaced apart discrete locations 501, 502 may be illuminated.

As illustrated in FIGS. 6a and 7a, the incident light source may be configured to project a focused light spot onto each discrete location 501, 502. Each focused light spot is aptly from order 1 micron to 100 microns in diameter, for example 10 to 20 microns, or 15 microns in diameter. The focused light spot 500 may be produced through use of at least one of: one or more optical lenses, fibre optics or light sources.

Intensity of light reflected from the Moiré fringe pattern is detected using the photodetector system. The photodetector system is configured to detect light intensity reflected from each of the first and second discrete locations 501, 502 on the Moiré fringe pattern 130. That is, the photodetector system is configured such that the intensity of light reflected from each discrete location (corresponding to a light spot) may be detected.

In the example shown in FIG. 2, the photodetector system may include a first photodetector (not shown) configured to detect light intensity reflected from the first discrete location 501, and a second photodetector (not shown) configured to detect light intensity reflected from the second discrete location 502. Each photodetector may be positioned adjacent to the sensor pad 100 on the side of the transparent substrate 140. In this way, light reflected from the first and second discrete locations 501, 502 on the Moiré fringe pattern 130 may pass through the transparent substrate 140 to the photodetectors in the photodetector system.

The photodetector system may aptly include a first fibre optic cable positioned to direct light reflected from the first discrete location to the first photodetector and a second fibre optic cable positioned to direct light reflected from the second discrete location to the second photodetector. The fibre optic cables may help to direct light reflected from each discrete location to the corresponding photodetector and help to prevent each photodetector from detecting light reflected from the ‘wrong’ discrete location. Detection of light intensity reflected from each discrete location enables measurement of the position of the Moiré fringe pattern, since the light and dark bands of the Moiré fringe pattern directly relate to the intensity of reflected light as discussed above.

The difference in intensity of light detected at each discrete location may therefore be used to map the position and phase change of the Moiré fringe pattern as discussed above in relation to FIGS. 7a and 7b.

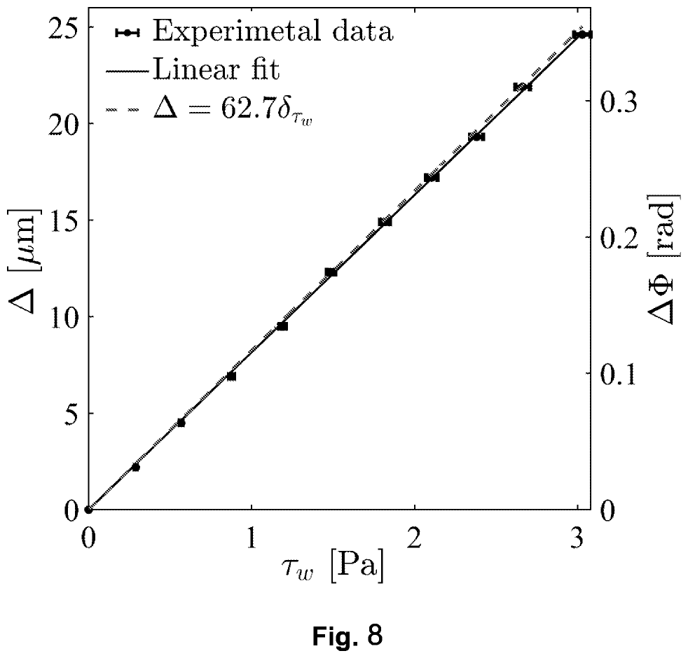

The phase change of the Moiré fringe pattern of the sensor 100 may be calibrated to allow direct mapping of instantaneous phase change to instantaneous wall shear stress. An example of the relationship between the displacement, Δ, of the Moiré fringe pattern 130, the phase difference, ΔΦ, and the applied wall shear stress, τ_{w}, is illustrated in FIG. 8. As shown, the displacement of the Moiré fringe pattern is directly proportional to the applied wall shear stress. The phase difference, ΔΦ, of the Moiré fringe pattern is directly proportional to the applied wall shear stress, τ_{w}.

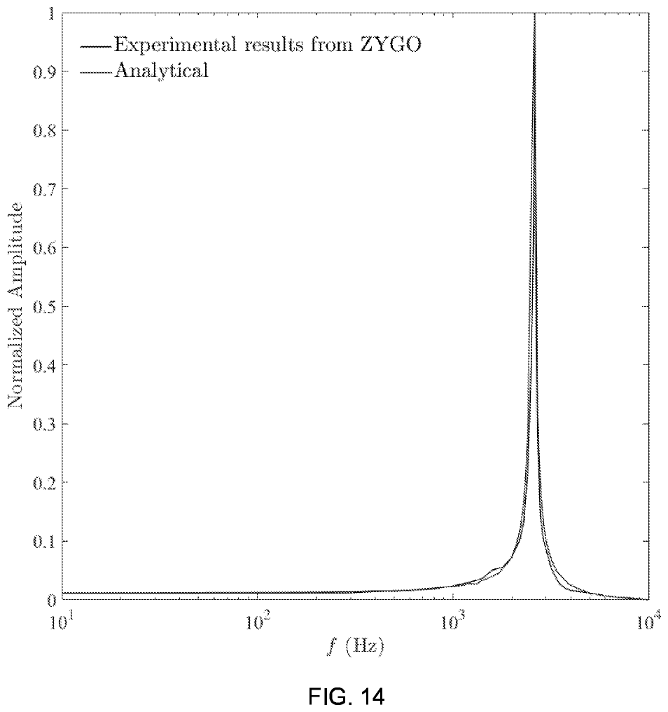

In FIG. 8, the dashed line is from an analytical expression developed to describe the sensor (described further below in relation to FIG. 14).

Referring back to FIGS. 1 and 2, the wall shear stress sensor pad 100 of this example is a MEMS device or “chip”. The MEMS device has a length and width less than 1 mm. In this example, the MEMS device is around 800 microns in width and 900 microns in length.

The sensor pad 100 includes the first and second optical gratings 110, 120. The sensor pad includes a substrate 140 supporting the first optical grating 110. That is, the first optical grating 110 may be disposed on a surface of the substrate. In this example, the first optical grating 110 is disposed on a surface of the substrate 140 which faces the second optical grating 120. The substrate 140 is aptly transparent such that incident and reflected light may pass therethrough. In this example, the substrate is formed from BF33 glass.

The substrate 140 is generally fixed such that it does not move in response to an applied shear-stress. For example, the substrate 140 may be fixed relative to an external surface (e.g. the surface of an object) at which turbulent flow is to be measured.

In this example, the wall shear stress sensor pad 100 further includes a floating element 150 supporting the second optical grating 120. That is, the second optical grating 120 may be disposed on a surface of the floating element 150. The floating element 150 is disposed in a plane substantially parallel to and spaced apart from the substrate 140. The floating element 150 and the substrate 140 are aptly spaced apart by 3 um to 10 um.

The first optical grating 110 and the second optical grating 120 are positioned in the same optical path. That is, the first optical grating 110 and the second optical grating 130 are superimposed such that incident light passing through the first optical grating 110 will pass through or reflect from the second optical grating 120.

The floating element 150 is configured for translational movement with respect to the substrate 140. In this way, the second optical grating 120 disposed on the floating element 150 may translate with respect to the first optical grating 110 disposed on the fixed substrate 140.

In this example, the floating element 150 is configured for translational movement along a single axis. For example, the floating element 150 is configured to translate back and forth along an axis corresponding to an x-axis of the Moiré fringe pattern 130. In this way, displacement of the floating element 150 may be seen as a phase shift in the Moiré fringe pattern 130. As such, the sensor pad of FIG. 2 may be suitable for use in a one-dimensional wall shear stress sensor.

The floating element may be formed from Silicon, which is opaque.

The floating element 150 is mounted with respect to the substrate 140 via at least one micro-spring 160. The micro-spring 160 is configured to allow the translational movement of the floating element 150 with respect to the substrate 140.

The micro-spring 160 may extend between the floating element 150 and a support arm 170. The support arm 170 is fixed relative to the substrate 140. In this example, the support arm 170 extends substantially perpendicularly away from the substrate 140 towards the plane of the floating element 150.

In this example, the micro-spring 160 includes a first and second micro-spring each having a serpentine configuration. The first and second serpentine micro-springs are disposed at opposite ends of the floating element 150 and may stretch and compress upon translation of the floating element 150 with respect to the substrate 140. Aptly, in this example, first and second serpentine micro-springs are disposed in the direction of the x-axis of the Moiré fringe pattern. It will be appreciated by those skilled in the art that the properties of the serpentine micro-spring may be selected according to the desired properties and desired translational movement of the floating element under a given applied wall shear stress.

The serpentine micro-spring structure allows translation of the floating element 150 in a direction corresponding to a central axis passing through each micro-spring 160 either side of the Moiré fringe pattern 130. This is shown by the direction of flow indicated in FIG. 1.

Such serpentine type of micro-springs have not previously been used in one-dimensional wall shear stress sensors.

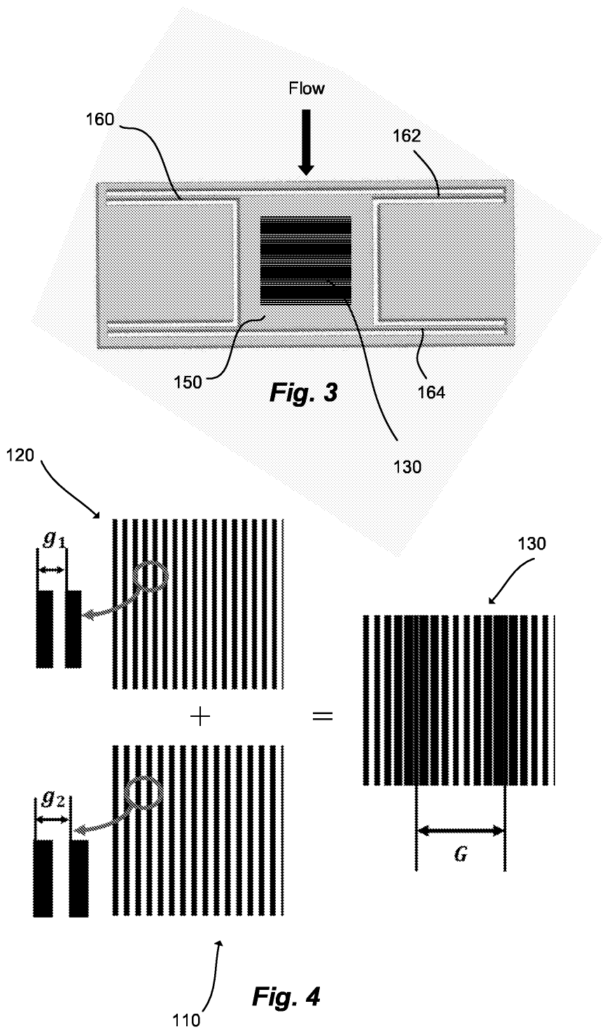

In another example, as shown in FIG. 3, the micro-spring 160 may include a clamped micro-spring disposed either side of the Moiré fringe pattern 130. That is, each clamped micro-spring is disposed adjacent to either the top or the bottom of the Moiré fringe pattern 130.

Each clamped micro-spring may include first and second elongate arms 162, 164 each fixed between the floating substrate 150 and a distal support that is fixed relative to the fixed substrate 140. In this example, each arm may have a width of around 7 microns. Again, it will be appreciated by those skilled in the art that the properties of the clamped micro-spring (e.g. the arm width and length) may be selected according to the desired properties and desired translational movement of the floating element 150 under a given applied wall shear stress.

The clamped micro-spring structure allows translation of the floating element 150 in a direction substantially orthogonal to the direction of extension of the elongate arms 162, 164. This is shown by the direction of flow indicated in FIG. 3.

In use, as fluid moves over the sensor pad, the floating element is free to move due to the micro-spring arrangement in the direction of the fluid flow whilst remaining parallel to the aero- or hydrodynamic surface in which the sensor is positioned. Since most industrial fluid flows of interest are turbulent, the floating element will oscillate back and forth, picking up chaotic motions of the fluid flow. Deflection of the floating element is very small, for example as low as tens of nanometres. Therefore, to detect the motion of the sensor the movement of the Moiré fringe pattern is tracked as described above. This helps to amplify the motion of the floating element by up to 120 times or more in the sensors described herein. The relatively large amplification of the motion is achieved in the design of the optical grating sets of the sensor, by appropriate selection of the first and second pitches g₁ and g₂ (see above regarding the Equation 1), in relation to the sensor size. In FIG. 14, for a dynamic harmonic response curve, the analytical solution is derived from solving the following ordinary differential equation:

M\ddot{x}+C\dot{x}+Kx=F₀ sin(ωt+ϕ)

in which

$$M = ρ {TW}_{e} {L}_{e}$$

$$C = \frac{{μL}_{e} {W}_{e}}{{h}_{gap}}$$

$$K = 4 {ET [ \frac{{W}_{t}}{{L}_{t}} ]}^{3} [ \frac{1}{( 1 + \frac{2 {W}_{t} {L}_{t}}{{W}_{e} {L}_{e}} )} ]$$

and ω is the external applying force frequency.

In this example, the resonant frequency from the Zygo measurement is 2620 Hz and from the analytical modelling it is 2575 Hz. It can be seen that the analytical modelling using the above equation gives a resonant frequency result very close to the measured result. It can therefore be said that this is an excellent design tool, since it can be predicted exactly how a sensor will perform, both statically (FIG. 8) and dynamically (FIG. 14) in terms of sensor deflection, before it has been made. It can also be seen from the results shown in FIG. 14 that the sensors can be designed to pick up a large range of frequencies. Depending on the application, the range of the resonant frequency will vary.

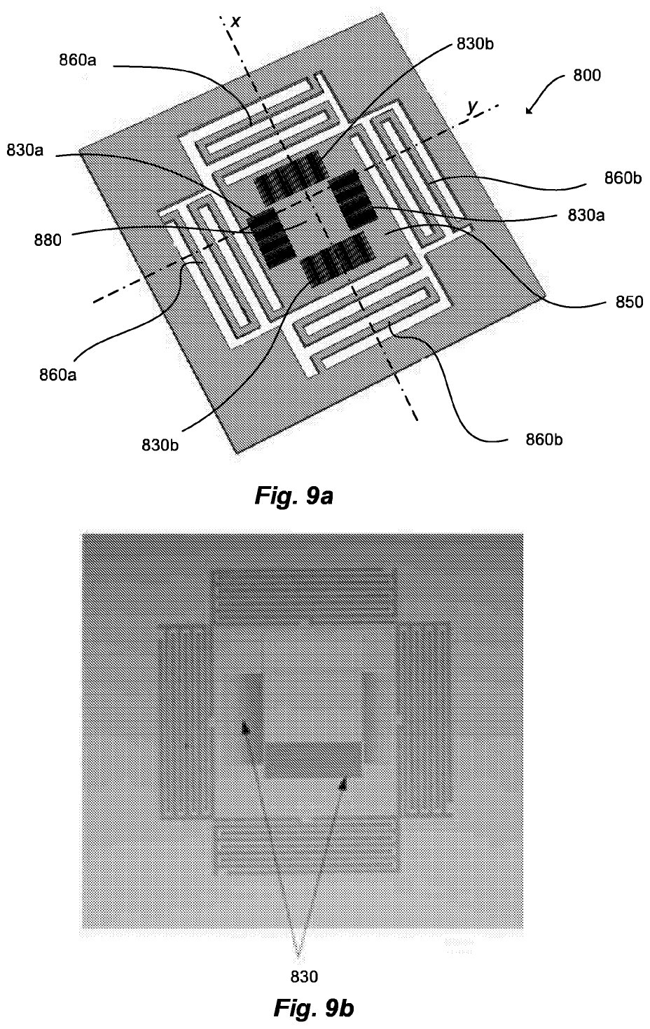

FIG. 9a illustrates a wall shear stress sensor pad 800 configured for use in a two-dimensional wall shear stress sensor. In this example, the sensor pad 800 includes a floating element 850 that is configured to translate in both a first direction and a second direction.

The sensor pad 800 may be configured similarly to those described above in relation to FIGS. 1 to 3, for example. However, in this example, the floating element 850 is supported by two pairs of micro-springs 860a, 860b. The first pair of micro-springs 860a allow translational movement of the floating element 850 in a first direction, x. The second pair of micro-springs 860b allow translational movement of the floating element 850 in a second direction, y. In this example, the first direction, x, is substantially perpendicular to the second direction, y. The first and second pairs of micro-springs 860a, 860b may include any suitable configuration to allow respective translational movement of the floating element. In this example each of the micro-springs are serpentine micro-springs.

Similarly to the example described above, the sensor pad 800 includes a fixed substrate. The fixed substrate may be transparent to allow incident and reflected light to pass therethrough. A plurality of optical gratings may be disposed on the fixed substrate. In other words, the fixed substrate may support a plurality of optical gratings. For example the fixed substrate may support one or more optical gratings oriented in a first direction and one or more optical gratings oriented in a second direction.

The floating substrate 850 (or floating element) supports a second plurality of optical gratings. Similarly to the fixed substrate, the floating substrate may support one or more optical gratings oriented in a first direction and one or more optical gratings oriented in a second direction.

The plurality of optical gratings disposed on the floating substrate 850 are positioned such that they are each superimposed over a corresponding optical grating on the fixed substrate. In this way, the superimposed optical gratings on each of the fixed substrate and floating substrate 850 form a plurality of Moiré fringe patterns, with at least one Moiré fringe pattern 830a oriented in a first direction and at least one Moiré fringe pattern 830b oriented in a second direction.

The Moiré fringe patterns 830a, 830b formed by the overlapping optical gratings are oriented such that the respective first and second directions are aligned with an axis of translation of the floating element 850. In this example, a first direction of the first Moiré fringe pattern 830a is oriented in the x direction, whilst a second direction of the second Moiré fringe pattern 830b is oriented in the y direction. As such, a phase shift in the first Moiré fringe pattern 830a will correlate to a displacement of the floating element in the x direction, whilst a phase shift in the second Moiré fringe pattern 830b will correlate to a phase shift in the y direction.

As shown, in this example, the first and second Moiré fringe patterns 830a, 830b are each discontinuous. That is, each Moiré fringe pattern 830a, 830b includes first and second portions formed by first and second pairs of optical gratings on the fixed substrate and floating substrate 850. A space 880 on the floating element separates the first and second portion of each Moiré fringe pattern 830a, 830b. The space 880 on each of the fixed substrate and floating substrate may be a region in which there are no optical gratings.

An SEM image of an example of the sensor pad of FIG. 9a is shown in FIG. 9b. As shown, the sensor pad includes two discontinuous Moiré fringe patterns 830a, 830b oriented in two directions corresponding to the axes of displacement of the floating element. It will be appreciated that other Moiré fringe pattern configurations may be possible in other two-dimensional sensor pads, with at least one Moiré fringe pattern oriented in each of the first and second directions.

The sensor pad of FIG. 9a may be incorporated into a two-dimensional wall

shear stress sensor. The two-dimensional wall shear stress sensor includes corresponding optoelectronics for each Moiré fringe pattern on the sensor pad. For example, the incident light source may be configured to illuminate each of the Moiré fringe patterns and a photodetector system may be provided to detect light intensity reflected from each Moiré fringe pattern. The sensor arrays work by essentially duplicating the optoelectronics for each sensor pad.

For example, the incident light source may be configured to illuminate a first discrete location and a second discrete locations on each of the Moiré fringe patterns. In the example shown in FIG. 9a having discontinuous Moiré fringe patterns, the first discrete location may be on a first portion of the Moiré fringe pattern and the second discrete location may be on a second portion of the Moiré fringe pattern.

For example, the incident light source may include a first pair of light sources and a second pair of light sources. The first pair of light sources may be configured to illuminate the first Moiré fringe pattern 830a oriented in the x direction and the second pair of the light sources may be configured to illuminate the second Moiré fringe pattern 830b oriented in the y direction. Each light source in the first and second pair of light sources is configured to illuminate a corresponding discrete location on the corresponding Moiré fringe pattern.

The incident light source may be configured to illuminate the Moiré fringe patterns oriented in a first direction with light having a first wavelength and illuminate the Moiré fringe pattern oriented in a second direction with light having a second wavelength different to the first wavelength. In this example, the first pair of light sources are configured to emit light having the first wavelength and the second pair of light sources are configured to emit light having the second wavelength.

A first photodetector system may be provided to detect light intensity reflected from the Moiré fringe pattern oriented in the first, x, direction, and a second photodetector system may be provided to detect light intensity reflected from Moiré fringe patterns oriented in the second, y, direction. The first photodetector system may be configured to detect light having the first wavelength and the second photodetector system may be configured to detect light having the second wavelength. As such, each photodetector system is configured to only detect light reflected from the corresponding Moiré fringe pattern.

Each photodetector system may include at least one photodetector and an optical cable. The optical cable may extend between the Moiré fringe pattern and the photodetector and is configured to transmit light reflected from the corresponding Moiré fringe pattern to the photodetector. Each photodetector may aptly include a first photodetector and a second photodetector. Each photodetector in the photodetector system is configured to detect light reflected from a different discrete location on the corresponding Moiré fringe pattern.

Each photodetector system may include an optical filter which may be used in conjunction with the photodetectors such that only the relevant wavelength of light is detected. As such, each photodetector can accurately detect reflected light associated with Moiré fringe patterns oriented in a single direction, thereby avoiding noise of light reflected from Moiré fringe patterns oriented in the other direction.

As an alternative arrangement, it is possible to use two different wavelengths of light, to mitigate interference. As a further alternative or additional arrangement, it is possible to pulse the two light sources, so one is on whilst the other is off, to mitigate interference.

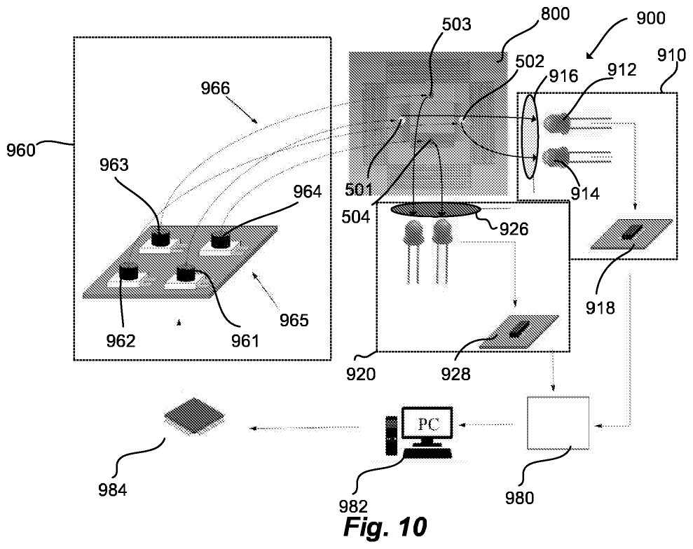

The configuration of the light source and the photodetector systems will now be described in more detail with reference to FIG. 10. FIG. 10 illustrates an example of a wall shear stress detector system 900 including a MEMS wall shear stress sensor. As discussed above, the wall shear stress sensor includes a sensor pad 800 having a first and second Moiré fringe patterns extending in first and second directions. The sensor pad is configured similarly to the sensor pads described above, so will not be described again in detail.

An incident light source 960 is configured to illuminate first and second discrete locations 501, 502 on a first Moiré fringe pattern 830a extending in a first direction and first and second discrete locations 503, 504 on a second Moiré fringe pattern 830b extending in a second direction. That is, the incident light source 960 may be configured to project a first and second light spot onto each Moiré fringe pattern, with the light spots being projected onto each discrete location. The first and second discrete locations on each Moiré fringe pattern are spaced apart along the relevant axis of displacement, as discussed above in relation to FIGS. 6 and 7.

In this example, the incident light source 960 includes a plurality of light sources 961-964. Each light source is configured to illuminate one of the discrete locations 501, 502, 503, 504 on the Moiré fringe patterns. That is, each light source is configured to project a single light spot onto a corresponding Moiré fringe pattern, with each light spot corresponding to one of the discrete locations 501, 502, 503, 504. Specifically, this example includes a first pair of light sources 961, 962, which are configured to illuminate corresponding discrete locations 501, 502 on a first Moiré fringe pattern 830a oriented in a first direction and a second pair of light sources 963, 964, which are configured to illuminate corresponding discrete locations 503, 504 on a second Moiré fringe pattern 830b oriented in a second direction.

In this example, each light source 961-964 is an LED integrated into a light source drive circuit 965. The incident light source 960 further includes a fibre optic cable 966 extending from each light source 961-964 (LED) to direct light towards a corresponding discrete location 501-504 on the corresponding Moiré fringe pattern.

Similarly to the example described above in relation to FIG. 7a, the incident light source 960 is configured to project a focused light spot onto each discrete location 501-504. Each focused light spot is aptly from order 1 micron to 100 microns in diameter, for example 10 to 20 microns, or 15 microns in diameter.

The incident light source 960 is aptly configured to provide constant illumination to each of the discrete locations 501-504 on the each of the first and second Moiré fringe patterns 830a, 830b. In this example, the constant illumination is provided by each of the light sources 961-964. Light emitted from each of the LEDs is directed to the corresponding discrete location via a corresponding fibre optic cable 966 to thereby project a focused light spot onto the corresponding discrete location 501-504. As an alternative to the constant illumination, light may be provided as a pulse effect, on a time scale quicker than any of the movement within the flow. In this way, the flow would effectively “see” the light as a constant. By providing a pulsed light, the cross talk between light sources/discrete locations may be reduced or mitigated.

The incident light source 960 may further include one or more optical lenses (not shown), which may include a pair of aspheric condenser lenses. The optical lenses may be positioned between the plurality of light sources 961-964 and the Moiré fringe patterns and are configured to focus light from the plurality of light sources 962 onto the corresponding discrete locations 501-504 as focused light spots. In this example, the optical lenses may be positioned between the fibre optic cables 966 and the Moiré fringe patterns. In this way, the optical lenses may be positioned to focus light from the fibre optic cables 966 such that it is projected onto the Moiré fringe patterns as focused light spots.

In this example, the LEDs of the first pair of light sources 961, 962 are configured to emit light having a first wavelength. The LEDs of the second pair of light sources 963, 964 are configured to emit light having a second wavelength different to the first wavelength.

As mentioned above, a first photodetector system 910 is provided to detect light intensity reflected from the Moiré fringe pattern 830a oriented the first direction, and a second photodetector system 920 is provided to detect light intensity reflected from Moiré fringe pattern 830b oriented in the second direction.

The first photodetector system 910 may be configured to detect light having the first wavelength and the second photodetector system 920 may be configured to detect light having the second wavelength. As such, each photodetector system is configured to only detect light reflected from the corresponding Moiré fringe pattern. Each photodetector system 910, 920 may include an optical filter 916, 926. Each optical filter 912, 922 may be configured to only pass light having a wavelength substantially the same as the light emitted from the corresponding pair of light sources.

In this example the first photodetector system 910 includes a first photodetector 912 and a second photodetector 914. Each photodetector 912 is configured to detect light reflected from a different discrete location on the corresponding Moiré fringe pattern.

The first and second photodetectors 912, 914 are positioned relative to the first Moiré fringe pattern 830a, such that light reflected from the first and second discrete locations 501, 502 may be detected by each of the first and second photodetectors 912, 914 respectively. In this example, fibre optic cables extend from each of the discrete locations 501, 502 to the corresponding photodetector 912, 914 to transmit light reflected from the discrete location to the corresponding photodetector.

The optical filter 916 is positioned between the Moiré fringe pattern and the photodetector to filter light transmitted to the photodetectors 912, 914. In this way, only light of relevant wavelength is detected by the photodetector 912, 914.

The second photodetector system 920 may similarly include first and second photodetectors, the optical filter 926 and fibre optic cables. These may each be configured similarly to those described in relation to the first photodetector system 910, so will not be described again in detail. However, it will be appreciated that the second photodetector system is configured to detect light reflected from the first and second discrete locations 503, 504 on the second Moiré fringe pattern rather than the first Moiré fringe pattern.

In use, the photodetectors of each photodetector system are able to detect intensity of light reflected from each discrete location individually the first and second Moiré fringe patterns. As such, this enables measurement of the position of each of the Moiré fringe patterns, since the light and dark bands of the Moiré fringe pattern directly relate to the intensity of reflected light.

Each photodetector detects reflected light and outputs a signal, which is indicative of detected light intensity. That is, the amplitude of the output signal corresponds to the reflected light intensity of the scanned point on the Moiré fringe pattern, and its phase signifies the position of the dark and light bands.

Each of the photodetector systems may further include a photo-detector amplifier circuit 918, 928 for amplifying the signal from the photodetectors.

The system may further include, a processor 980, a PC 982, and a micro-controller 984 for controlling the light source drive circuit 964.

The processor 980 is configured to receive a signal from the photodetectors in each photodetector system, which is indicative of detected light intensity at each discrete location, and analyse the received data to determine a shape and position of the first and second Moiré fringe patterns. For example, the sinusoidal response of the each of the Moiré fringe patterns may be determined.

The processor 980 may then calculate the phase shift of each of the Moiré fringe patterns and use this to determine displacement of the floating element and the corresponding wall shear stress imparted on the sensor. The displacement of the first Moiré fringe pattern correlates to displacement of the floating element in the first direction and displacement of the second Moiré fringe pattern correlates to displacement of the floating element in the second direction. Since displacement of the floating element is directly related to wall shear stress imparted on the sensor, the wall shear stress can be determined in two dimensions.

In use, light from the first and second pair of light sources in the drive circuit 965 is launched down the corresponding fibre optic cable 966 and is then focused to a small spot of light at the corresponding discrete locations 501-504 on the back side of the respective Moiré fringe pattern. The spot of light is typically in the order of 10 microns in diameter, depending on the size of the floating element and Moiré fringe pattern. The light spots are projected continuously and thus position of the Moiré fringe patterns can continuously be tracked by the photodetector systems 910, 920.

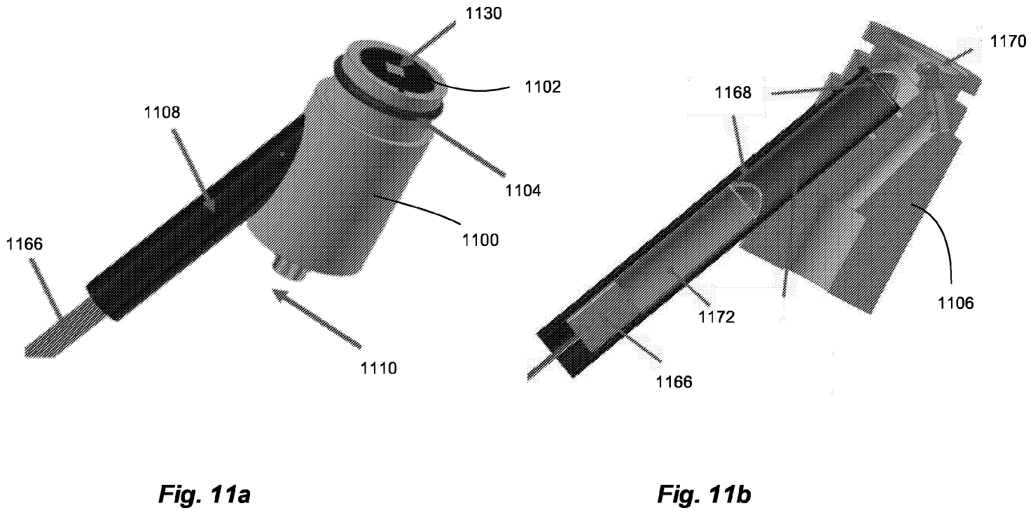

FIGS. 11a and 11b illustrate an example of a MEMS sensor packaging or housing.

Here, each of the sensor components are embedded in a housing 1100. The housing 1100 includes a sensor surface 1102 on which the sensor pad including the one or more Moiré fringe patterns 1130 is disposed. In use, the sensor surface 1102 may be arranged to be flush with a surface of an object for which wall shear stress is to be measured. As such, turbulent flow over the surface of the object will impart a shear-stress to the floating element of the sensor pad and result in a phase shift in the one or more Moiré fringe patterns as described above.

An O-ring seal 1104 may be positioned around the surface 1102 to provide a seal against the surface of the object for which wall shear stress is to be measured and prevent fluid ingress into internal components of the sensor.

The housing 1100 further includes a main housing body 1106 configured to house the photodetector 1170. In this example, only one photodetector is shown. However, it will be appreciated that the housing body may house one or more photodetectors or photodetector systems depending on the configuration of the sensor optoelectronics. In this example, the photodetector 1170 is positioned behind the Moiré fringe pattern 1130 so as to detect light reflected therefrom. In other examples, one or more optical cables may form part of the photodetector system and extend between each photodetector and the Moiré fringe pattern.

The main housing body 1106 further includes a sensor output 1110 for output of the electronic signal from the photodetector 1170.

The housing 1100 also includes an elongate housing portion 1108 extending from the main housing body 1106. The elongate housing portion 1108 is configured to house the optical components of the sensor, including the fibre optic cables 1166 and a pair of optical lenses 1168. This example also includes a first and second spacer 1172. The first spacer 1172 is positioned between the fibre optic cables 1166 and the lenses 1168 and the second spacer is positioned between the lenses 1168.

The fibre optic cables 1166 may be in communication with a light source, for example an LED, as described above in relation to FIG. 10. As shown in FIG. 11b, the lenses 1168 and fibre optic cables 1166 are positioned such that light from the light source can be directed along the fibre optic cables 1166, and focused via the lenses 1168 onto a back side of the Moiré fringe pattern 1130.

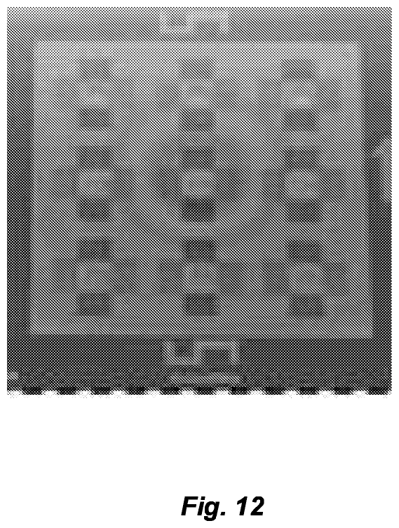

FIG. 12 illustrates an SEM image of two-dimensional wall shear stress sensor array.

Various modifications to the detailed arrangements as described above are possible without departing from the scope of the claims.

Although in the examples described above, the incident light source is configured to project two light spots onto two corresponding discrete locations on each Moiré fringe pattern, it will be appreciated that the incident light source may be configured to project other numbers of light spots onto corresponding discrete locations on the Moiré fringe pattern. For example, the incident light source may be configured to illuminate at least two discrete locations, or from 2 to 10 discrete locations, or from 4 to 6 discrete locations on the Moiré fringe pattern. As described above, an optical cable may be provided for each light source to help direct the light to the corresponding discrete location on the Moiré fringe pattern.

In other examples, the incident light source may be configured to illuminate the whole sensor pad and therefore the whole of each Moiré fringe pattern. In this case, the photodetector system or systems may include fibre optic cables extending from discrete locations on each of the Moiré fringe patterns to thereby detect intensity of light reflected from the discrete locations. The phase shift in the Moiré fringe patterns can then be determined in the same way as described above.

Although LEDs are shown in the example above, the incident light source may include other types of light source including coherent or non-coherent light sources. For example, the incident light source may include a non-coherent light source including at least one of LEDs, OLEDs, QLEDs. In other examples, the incident light source may include a coherent light source, for example one or more laser light sources. Coherent light sources may have the advantage of enabling more focused light spots, which may help to increase the accuracy or resolution of the sensors.

Although the system described above in relation to FIG. 10 includes fibre optic cables to help direct the light to the corresponding Moiré fringe pattern, in other examples, the fibre optic cables may be omitted. For example, it may be possible to position the light source to directly illuminate the corresponding discrete location on the corresponding Moiré fringe pattern.

Whilst example dimensions have been provided above for the diameter of the focused light spots which are projected onto the discrete locations, it will be appreciated that different size light spots may be utilised. The diameter of the light spots may aptly be selected dependent on the size of the floating element. The size of the light spots may optionally be adjusted through the use of optical lenses. For example, the distance between two optical lenses may be adjusted to adapt the size of the light spots projected onto the Moiré fringe pattern. In this way, the size and position of the projected light spots may be fine tuned so that they are distributed across the whole width of the Moiré fringe pattern.

Whilst the photodetector systems in the example described above includes a plurality of photodetectors each configured to detect light reflected from one of the discrete locations, it will be appreciated that each photodetector system may include only one photodetector configured to detect light reflected from both discrete locations on the Moiré fringe pattern. In this arrangement, the incident light source may be configured to project light alternately at high frequency (e.g. 100 Hz to MHz) onto each discrete location on the Moiré fringe pattern. In this way, only one discrete location on the corresponding Moiré fringe pattern is illuminated at once and the photodetector system can track the position of the Moiré fringe pattern over time using the detected light intensity from each discrete location.

The optical gratings described above may be fabricated in various ways. For example, the optical gratings may include patterning gold on the silicon and BF33 substrate using lithography and lift-off processes.

The sensor resolution of the above described sensors may be up to twice as good as other commercially available sensors. In terms of size-for-size comparison, the resolution of the above-described sensors may be up to 40 times better compared to optical sensors of comparable size.

As mentioned above, the incident light source is configured to illuminate at least a first and second discrete location distributed across each Moiré fringe pattern. Each of the discrete locations are aptly spaced apart in the x direction of the Moiré fringe pattern. That is, the discrete locations are spaced apart along the translational axis of the corresponding Moiré fringe pattern.

With the dual LED/photodetector arrangements described, this approach allows us to instrument the sensor arrays so we can obtain measurements of instantaneous wall shear stress in two directions, simultaneously, over an area.

The use of serpentine micro-springs as described above may help to improve the response of the floating element. This results in more sensitive sensors with higher accuracy and resolution in the MEMS wall shear stress sensor.

The sensors described above enable measurement of instantaneous wall shear stress using an optical transduction approach. This transduction is immune to external conditions such as EMI, out of plane vibration effects, temperature effects, and hence can be used in different environment including harsh testing environments. There is no need for wire bindings and the sensor performs in a non-contact situation with the associated opto-electronics. Moreover, using the Moiré fringe pattern, specifically, provides the ability to amplify the mechanical displacement of the device, which enables the quantification of smaller wall shear stress values compared to known techniques.

The sensors described herein have a further advantage that they do not suffer from electrical noise and maintain performance in a wide range of temperatures, in particular high temperatures.

The sensor configurations described herein enable the sensors to be fabricated much smaller than known sensors whilst still maintaining the same or improved sensor resolution. This is particularly beneficial in the field of fluid dynamics where it is critical that the sensor itself does not have any significant affect on the fluid flow over a surface.

### EXAMPLES

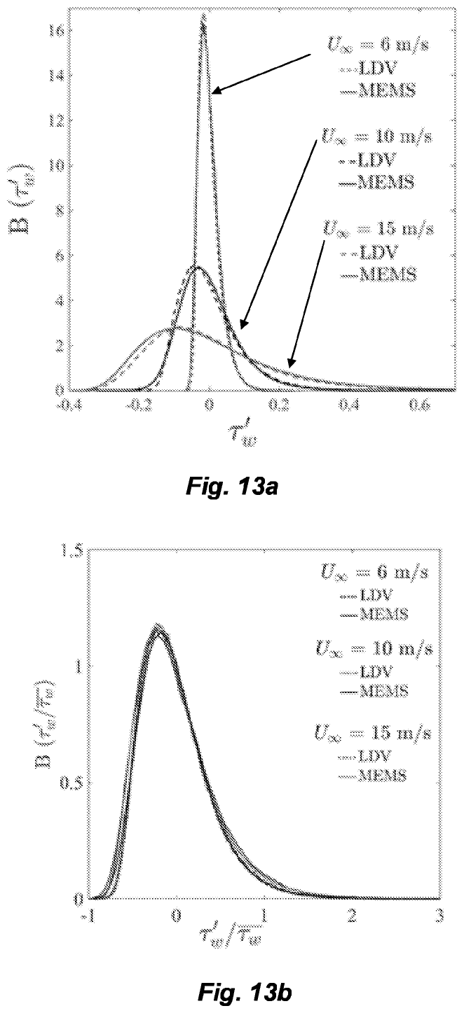

FIGS. 13a and 13b illustrate experimental results from wind tunnel tests. Here the sensor of the present invention is implemented inside the wind tunnel to measure the turbulent flow alongside a commercially available technique—Laser Doppler velocimetry (LDV). The LDV is positioned within the viscous sublayer to measure fluctuating wall shear stress. The LDV and the MEMS sensor data is acquired simultaneously. FIG. 13a shows probability density functions of fluctuating wall shear stress for U_{∞}=6 m/s, U_{∞}=10 m/s, and U_{∞}=15 m/s, measured by LDV (dashed lines) and MEMS sensor (solid lines). FIG. 13b shows probability density functions of normalized fluctuating wall shear stress for U_{∞}=6 m/s, U_{∞}=10 m/s, and U_{∞}=15 m/s, measured by LDV (dots) and MEMS sensor (solid lines).

The results in FIGS. 13a and 13b can be interpreted as follows. The MEMS sensor and LDV data collapse (i.e. the results from the MEMS sensor follow the results from the LDV extremely closely), validating that the MEMS sensor accurately captures the instantaneous wall shear stress fluctuations of the turbulent flow, noting that the accuracy of LDV is within c. 1%.

The MEMS sensors allow a direct measurement of wall shear stress; LDV is an indirect measurement of wall shear stress where the LDV probe is positioned within the viscous sublayer of the flow. The viscous sublayer is typically a few hundred microns thick and is the region closest to the wall. Here, the LDV system measures the velocity within the viscous sublayer, which is transformed into wall shear stress by invoking Newton's law of viscosity. An LDV system is large and expensive, allowing measurement at a single location. Further, as the Reynolds number increases, the thickness of viscous sublayer decreases, such that, eventually, the LDV probe would no longer fit within the viscous sublayer, and thereby would no longer be able to be used to measure the wall shear stress. In contrast, the MEMS sensors remain fully functional up to high Reynolds number fluid flows.

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A two-dimensional wall shear stress sensor comprising:
a fixed substrate supporting a first plurality of optical gratings;
a floating substrate supporting a second plurality of optical gratings superimposed over the first plurality of optical gratings to form a plurality of Moiré fringe patterns comprising at least a first Moiré fringe pattern extending in a first direction and a second Moiré fringe pattern extending in a second direction different to the first direction;
wherein the floating substrate is displaceable relative to the fixed substrate in response to a wall shear stress imparted on the sensor, wherein displacement of the floating substrate correlates with a phase shift in at least one of the first and second Moiré fringe patterns; an incident light source configured to illuminate each of the plurality of Moiré fringe patterns;
a first photodetector system configured to detect intensity of light reflected from the first Moiré fringe pattern; and
a second photodetector system configured to detect intensity of light reflected from the second Moiré fringe pattern.

2. A two-dimensional wall shear stress sensor according to claim 1, wherein each optical grating in the second plurality of optical gratings overlaps a corresponding optical grating in the first plurality of optical gratings.

3. A two-dimensional wall shear stress sensor according to claim 1, wherein the floating substrate is displaceable relative to the fixed substrate in the first direction and the second direction.

4. A two-dimensional wall shear stress sensor according to claim 3, wherein displacement of the floating substrate in the first direction correlates with a phase shift of the first Moiré fringe pattern, and displacement of the floating substrate in the second direction correlates with a phase shift of the second Moiré fringe pattern.

5. A two-dimensional wall shear stress sensor according to claim 1, wherein the floating substrate is suspended relative to the fixed substrate by at least one micro-spring.

6. A two-dimensional wall shear stress sensor according to claim 5, wherein the at least one micro-spring is configured to allow displacement of the floating element with respect to the fixed substrate in both the first direction and second direction in response to an applied wall shear stress.

7. A two-dimensional wall shear stress sensor according to claim 5, wherein the at least one micro-spring comprises a serpentine micro-spring or a clamped micro-spring.

8. A two-dimensional wall shear stress sensor according to claim 1, wherein the incident light source is configured to illuminate a first discrete location and a second discrete location on each of the first and second Moiré fringe patterns.

9. A two-dimensional wall shear stress sensor according to claim 8, wherein the incident light source is configured to project a focused light spot onto each discrete location.

10. A two-dimensional wall shear stress sensor according to claim 9, wherein the focused light spot is from order 1 micron to order 100 microns in diameter microns in diameter.

11. A two-dimensional wall shear stress sensor according to claim 8, wherein the incident light source comprises a first pair of light sources configured to illuminate the first and second discrete locations on the first Moiré fringe pattern and a second pair of light sources configured to illuminate the first and second discrete locations on the second Moiré fringe pattern.

12. A two-dimensional wall shear stress sensor according to claim 11, wherein the first pair of light sources are configured to emit light having a first wavelength and the second pair of light sources are configured to emit light having a second wavelength.

13. A two-dimensional wall shear stress sensor according to claim 12, wherein the first wavelength is different to the second wavelength.

14. A two-dimensional wall shear stress sensor according to claim 11, wherein each pair of light sources comprises a first and second light emitting diode (LED).

15. A two-dimensional wall shear stress sensor according to claim 11, wherein the incident light source further comprises a fibre optic cable extending from each light source in the first and second pair of light sources to direct light towards a corresponding discrete location on the corresponding Moiré fringe pattern.

16. A two-dimensional wall shear stress sensor according to claim 11, wherein the incident light source further comprises at least one optical lens positioned between the first and second pair of light sources and the first and second Moiré fringe patterns, wherein the at least one optical lens is configured to focus light from the first and second pair of light sources onto corresponding discrete locations on the corresponding Moiré fringe pattern.

17. A two-dimensional wall shear stress sensor according to claim 8, wherein the incident light source is configured to provide constant illumination to each of the first and second discrete locations on each of the first and second Moiré fringe patterns.

18. A two-dimensional wall shear stress sensor according to claim 1, wherein an output from each of the first and second photodetector systems is indicative of detected light intensity.

19. A two-dimensional wall shear stress sensor according to claim 1, wherein the first photodetector system is configured to detect light having a first wavelength, and the second photodetector system is configured to detect light having a second wavelength different to the first wavelength.

20. A two-dimensional wall shear stress sensor according to claim 20, wherein at least one of the first and second photodetector systems comprises an optical filter.

21. A two-dimensional wall shear stress sensor according to claim 1, wherein each of the first and second photodetector systems comprises at least one photodetector and an optical cable configured to transmit light reflected from the corresponding Moiré fringe pattern to the photodetector.

22. A two-dimensional wall shear stress sensor according to claim 1, wherein each of the first and second photodetector systems comprises a first photodetector and a second photodetector, wherein each photodetector is configured to detect light reflected from a different discrete location on the corresponding Moiré fringe pattern.

23. A two-dimensional wall shear stress sensor according to claim 22, wherein each of the first and second photodetector systems comprises an optical cable extending between each photodetector and a corresponding discrete location on the corresponding Moiré fringe pattern.

24. A two-dimensional wall shear stress sensor according to claim 1, wherein the wall shear stress sensor is a micro-electro-mechanical-system wall shear stress sensor.

25. A two-dimensional wall shear stress detector system comprising the wall shear stress sensor according to any preceding claim, the system further comprising a processor, wherein the processor is configured to:
receive a signal from the first and second photodetector systems indicative of detected light intensity at each Moiré fringe pattern;
analyse the received data to determine a shape and position of the first and second Moiré fringe patterns;
calculate, from the shape and position, a phase shift of the each of the first and second Moiré fringe patterns; and
determine, using the calculated phase shift, a displacement of the floating element with respect to the fixed substrate and a corresponding wall shear stress imparted on the sensor.

26. A method of measuring wall shear stress using the wall shear stress sensor according to claim 1, the method comprising:
analysing the detected light intensities from each photodetector system to determine a shape and position corresponding to the first and second Moiré fringe patterns;
calculating, from the shape and position, a phase shift of each of the first and second Moiré fringe patterns; and
determining, using the calculated phase shift, a displacement of the floating element with respect to the substrate and a corresponding wall shear stress imparted on the sensor.

27. A computing device comprising a processor configured to carry out the method according to claim 26.

28. A machine-readable storage medium storing a computer program comprising instructions arranged, when executed, to implement the method of claim 26.

29. A one dimensional wall shear stress sensor comprising:
a first optical grating;
a second optical grating overlapping the first optical grating such that the first optical grating and second optical grating form a Moiré fringe pattern, wherein the second optical grating is displaceable relative to the first optical grating in response to a wall shear stress imparted on the sensor, and wherein displacement of the second optical grating correlates with a phase shift in the Moiré fringe pattern;
an incident light source configured to illuminate at least a first discrete location and a second discrete location on the Moiré fringe pattern;
a first photodetector configured to detect light intensity reflected from the first discrete location; and
a second photodetector configured to detect light intensity reflected from the second discrete location.
